(19) United States
(12) Patent Application Publication
(10) Pub. No.: US 2011/0148305 A1
(43) Pub. Date: Jun. 23, 2011

(54) DIELECTRIC BARRIER DISCHARGE LAMP

(75) Inventors: Daiyu Hayashi, Koln (DE); Georg Greuel, Roetgen (DE); Rainer Hilbig, Aachen (DE); Norbert Braun, Aachen (DE)

(73) Assignee: KONINKLIJKE PHILIPS ELECTRONICS N.V., EINDHOVEN (NL)

(21) Appl. No.: 13/059,372

(22) PCT Filed: Aug. 14, 2009
(86) PCT No.: PCT/IB09/53594

§ 371 Date: Feb. 16, 2011

(30) Foreign Application Priority Data
Aug. 21, 2008 (EP) 08105095.7

(51) Int. Cl. H01J 61/52; H01J 61/00; H01J 61/26

(52) U.S. Cl. 315/115; 313/567; 313/554

(57) ABSTRACT

It is provided a dielectric barrier discharge lamp with a metal material in the gas discharge vessel. The metal material increases the efficacy of the lamp.

### FIELD OF THE INVENTION

The invention relates to the field of dielectric barrier discharge lamps.

### BACKGROUND OF THE INVENTION

Dielectric barrier discharge (DBD) lamps are known in the field for many years. They are used in a wide range of applications, for instance, surface-modification, ozone and radical molecule generation, light generation, disinfection of organic and inorganic materials, etc. DBD-lamps are commonly used for various purposes, e.g., in copy machines or as illumination for advertising purposes. They generate light radiation in the wavelength range from vacuum ultraviolet to infrared in a short duration time.

They are used for various ranges of applications and products.

Principally DBD-lamps are run in that alternatively changing voltage is applied between two electrodes, at least one of which is or two of them are covered by dielectric materials. An electric discharge is excited in gas filled in the gap between the two electrodes. Light emissions are generated from the gas discharges. In some cases, the light emissions from the gas discharge are converted to the light of other wavelengths by fluorescent and phosphorescent materials locating inside or outside of the lamp envelope.

It is experimentally known that when the electric input power to the gap becomes larger, the discharge tends to be contracted. Narrow arc channels are formed in the gap, in contract to the diffuse discharges for lower input power. The efficiency of generating light emissions becomes then smaller for higher input power.

From experimental and theoretical studies in decades, it is known that high efficiency of generating light emissions per input electric power is attained only for diffuse discharge operations, and not for the contracted arc operations. However, although constant efforts have been made in the prior art, it was not possible to create a DBD-lamp, in which it was possible to keep the discharges diffuse for higher input power.

### SUMMARY OF THE INVENTION

It is an object of the invention to provide a dielectric barrier discharge lamp which is at least partly to overcome the disadvantages of the prior art and able to sustain diffuse discharges for higher input power.

This object is achieved by a dielectric barrier discharge lamp for providing ultraviolet light, comprising a discharge gas whereby at least one metal material is provided with the discharge gas.

In the context of the present invention the term “metal material” especially comprises and/or includes any elements commonly named as metals, but also elements, which are named as “half-metals” or “metalloids” (e.g. Gallium or Indium) as well as any alloys or other suitable combination of these materials.

It should be noted that the term “metal material” does not mean to imply that the actual embodiment and/or application excludes the providement of said at least one metal material in non-metallic form, e.g. as a salt.

In the context of the present invention the term “discharge gas” especially comprises and/or includes gaseous materials (i.e., atoms and molecules) and gaseous electric carrier species generated by electric discharges.

In the context of the present invention the term “provided with” especially comprises and includes that the at least one metal material is at least partly provided in the vessel, which contains the discharge gas. In most actual applications this will be the space between the outer and the inner tube of the DBD-lamp although this is no limitation of the invention.

The use of such a DBD-lamp has shown for a wide range of applications within the present invention to have at least one of the following advantages:

It is possible to run the DBD-lamp at much higher input powers, thereby reaching higher amounts of light emissions without reducing the efficiency of generating light emissions for a given input power.

According to an embodiment of the present invention, the DBD-lamp is an excimer lamp of gaseous materials. In this case it is especially preferred that the at least one metal material is provided in form of the metal or alloys thereof, preferably in solid form, e.g. as a block or as a powder, or that the at least one metal material is provided as a halide salt, e.g. a chloride or fluoride salt.

According to an embodiment of the present invention, the DBD-lamp is a lamp without fluorescent and/or phosphorescent materials locating inside or outside of the lamp envelope.

According to an embodiment of the present invention, the DBD-lamp is a lamp provided with fluorescent and/or phosphorescent materials locating inside or outside of the lamp envelope.

According to an embodiment of the present invention, the at least one metal material has a vapor pressure of ≦1.6×10² Pa at 400 K. This has proven itself in practice, especially due to the low pressure build-up of the metal material in the lamp during operation. Preferably, the at least one metal material has a vapor pressure of ≦1.2×10² Pa at 400 K, more preferred ≦1×10² Pa at 400 K and most preferred ≦0.8×10² Pa at 400 K.

According to an embodiment of the present invention, the at least one metal material has a melting point of ≦400 K. By doing so, for many applications problems with the structure of the metal material may be avoided. Preferably, the at least one metal material has a melting point of ≦500 K, more preferred the at least one metal material has a melting point of ≦700 K.

According to an embodiment of the present invention, the amount of the at least one metal material is ≧3×10⁻³ kg per m³ of the filling volume of the DBD-lamp. This amount has shown to be suitable for many applications within the present invention. Preferably, the amount of the at least one metal material is ≧4×10⁻³ kg per m³ of the filling volume of the DBD-lamp, more preferred ≧5×10⁻³ kg per m³ of the filling volume of the DBD-lamp

According to an embodiment of the present invention, the at least one metal material is selected from the group comprising the elements; Aluminum, Gallium, Indium, Thallium, Silicon, Germanium, Tin, Lead, Magnesium, Calcium, Strontium, Barium, Cupper, Silver, and Gold, or mixtures thereof.

The present invention also relates to the use of at least one metal material for increasing the radiance of the light emissions of a DBD-lamp or/and sustaining gas discharge channels in a DBD-lamp diffuse for higher input power in the DBD-lamp.

According to an embodiment of the present invention, the at least one metal material has a vapor pressure of ≦1.6×10² Pa at 400 K. This has proven itself in practice, especially due to the low pressure build-up of the metal material in the lamp during operation. Preferably, the at least one metal material has a vapor pressure of ≦1.2×10² Pa at 400 K, more preferred ≦1×10² Pa at 400 K and most preferred ≦0.8×10² Pa at 400 K.

According to an embodiment of the present invention, the at least one metal material has a melting point of ≧400 K. By doing so, for many applications problems with the structure of the metal material may be avoided. Preferably, the at least one metal material has a melting point of ≧500 K, more preferred the at least one metal material has a melting point of ≧700 K.

According to an embodiment of the present invention, the amount of the at least one metal material is ≧3×10⁻³ kg per m³ of the filling volume of the DBD-lamp. This amount has shown to be suitable for many applications within the present invention. Preferably, the amount of the at least one metal material is ≧4×10⁻³ kg per m³ of the filling volume of the DBD-lamp, more preferred ≧5×10⁻³ kg per m³ of the filling volume of the DBD-lamp

According to an embodiment of the present invention, the at least one metal material is selected from the group comprising the elements; Aluminum, Gallium, Indium, Thallium, Silicon, Germanium, Tin, Lead, Magnesium, Calcium, Strontium, Barium, Cupper, Silver, and Gold, or mixtures thereof.

The present invention furthermore relates to a method for increasing the performance of a DBD-lamp according to the present invention, comprising the step of heating the DBD-lamp.

This has surprisingly shown to increase the radiance of the DBD-lamp for many applications within the present invention.

According to an embodiment of the present invention, the method comprises the step of heating the DBD-lamp to at least a temperature of 50 degrees below the average melting temperature of the at least one metal material.

The present invention also relates to the use of at least one metal material as an oxygen getter in DBD-lamps.

A DBD-lamp according to the present invention and/or making use according to the invention may be of use in a broad variety of systems and/or applications, amongst them one or more of the following:

surface-modification,

ozone and/or radical molecule generation,

light generation,

disinfection of organic and inorganic materials,

copy machines

illumination applications

The aforementioned components, as well as the claimed components and the components to be used in accordance with the invention in the described embodiments, are not subject to any special exceptions with respect to their size, shape, compound selection and technical concept such that the selection criteria known in the pertinent field can be applied without limitations.

### BRIEF DESCRIPTION OF THE DRAWINGS

Additional details, features, characteristics and advantages of the object of the invention are disclosed in the sub claims, the figures and the following description of the respective figures and examples, which—in an exemplary fashion—show several embodiments and examples of inventive DBD-lamps.

In the drawings:

FIG. 1 is a sectional side view of a DBD-lamp according to one embodiment of the present invention.

FIG. 2 shows a diagram of the UV intensity as a function of the frequency for two inventive embodiments of the present invention and two comparative embodiments;

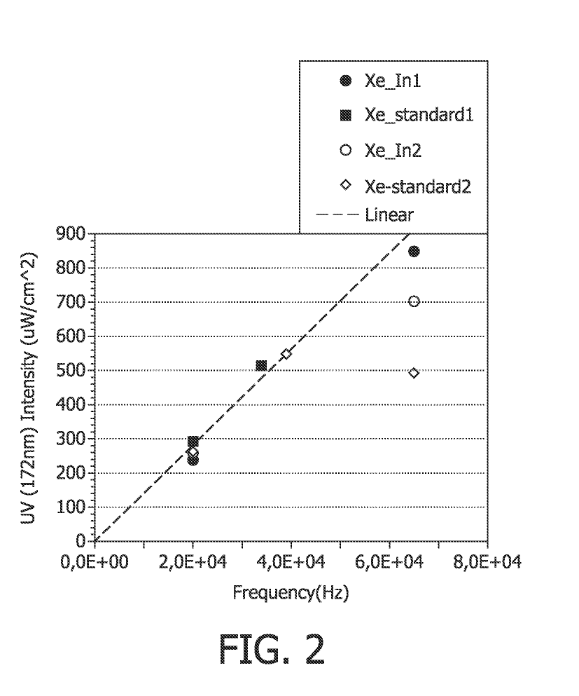

FIG. 3 shows a diagram of the Efficiency (in %) as a function of the Input Power for one further inventive embodiment of the present invention and one comparative embodiment;

FIG. 4 shows a diagram of the input power as a function of the frequency for the lamps of FIG. 3; and

FIG. 5 shows the amount of degradation of the phosphorescent material and the decrease in the light output as a function of the lifetime for a further inventive embodiment and a comparative embodiment.

### DETAILED DESCRIPTION OF EMBODIMENTS

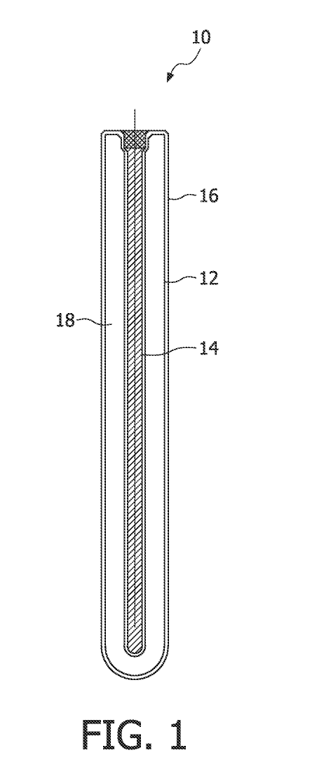

In the in FIG. 1 illustrated first embodiment of the dielectric barrier discharge lamp 10 which may be of use for the present invention. The dielectric barrier discharge lamp 10 comprises an outer tube 12 and an inner tube 14 arranged coaxial to the outer tube 12. The dielectric barrier discharge lamp 10 comprises an outer electrode 16, which may be a conductive coating or preferably a conductive meshed web. The outer electrode 16 may be arranged on the outside or the inside of the outer tube 12.

The space 18 between the inner 14 and outer tube 12 is filled with a discharge gas; also the at least one metal material is provided in this space 18.

According to some applications and/or embodiments of the present invention, fluorescent and/or phosphorescent materials are located on the inner 14 and outer tube 12 or outside of the lamp. The fluorescent and phosphorescent materials convert the light emissions from the gas discharge to the light of other wavelengths.

It should be noted that the DBD-lamp shown in FIG. 1 itself is prior art and also non-limiting for the present invention, which may be used with all DBD-lamps known to the skilled person in the art.

### EXAMPLES

The present invention will furthermore be understood by the following Example I to III which are intended for illustration only and are non limiting for the present invention.

### Example I

A cylindrical quartz glass DBD lamp (length 23 cm, diameter 2.4 cm) of the gap distance of 4 mm was filled with 300 mbar Xe gas together with metallic Indium piece of the weight ˜3.0 mg.

### Comparative Example I

As a comparative Example I the same lamp, only without the Indium was used.

The inventive and comparative Examples were then run the following way:

A-few-kV-voltage of the alternatively changing polarity was applied to the gap of the lamp with a frequency between 20-65 kHz. The magnitude of the applied voltage was constant. For each voltage cycle, a discharge is excited in the gap of the lamp.

The light emission intensity from Xe₂ excimer at the wavelength around 170 nm was measured as a function of the driving frequency. Since the applied voltage is constant here, and discharge current of repeated discharges is always the same, increasing the driving frequency means increasing input energy per time, thus, electric power.

FIG. 1 shows the dependence of the light emission intensity (vertical axis) from two DBD lamp filled with and without Indium metal as a function of the driving frequency, thus, the input power (horizontal axis).

The term “Xe-standard1 and 2” represent two lamps without Indium filling (comparative Example I, filled dots), whereas Xe_In1 and 2 represent two lamps with Indium filling (inventive Examples made according to Example I, hollow dots). The exact data is shown in Table I

TABLE I

| Frequency (Hz) | Xe_In1 | Xe_In2 | Xe_standard1 | Xe_standard2 |
|---|---|---|---|---|
| 2.00E+04 | 240 | 260 | 295 | 264 |
| 3.40E+04 | | | 516 | |
| 3.90E+04 | | | | 550 |
| 6.50E+04 | 850 | 702 | | 492 |
| 8.00E+04 | | | | |

The emission intensity increases linear to the input power for the lamps with Indium, while for the lamps without Indium the emission intensity reached its maximum at around 40 kHz, and then decreases with increasing input power. Therefore the inventive lamps can be run more efficient at high input power than the comparative lamps.

### Example II

In Example II a lamp was made according to Example I, only that Gallium instead of Indium is used.

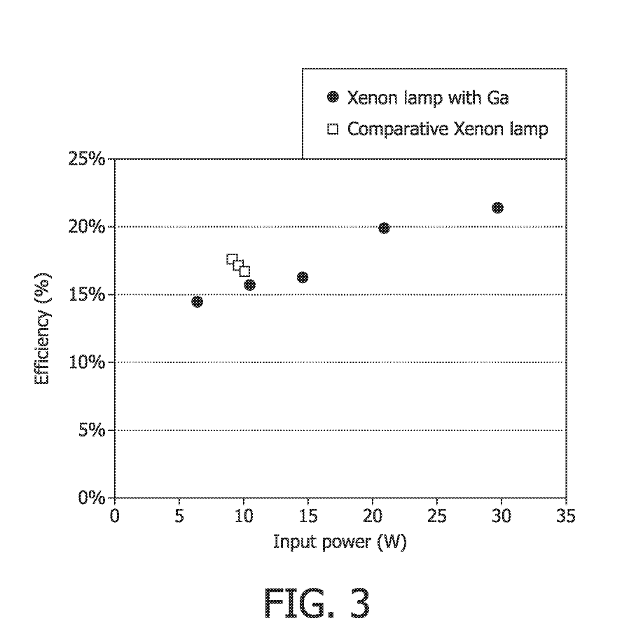

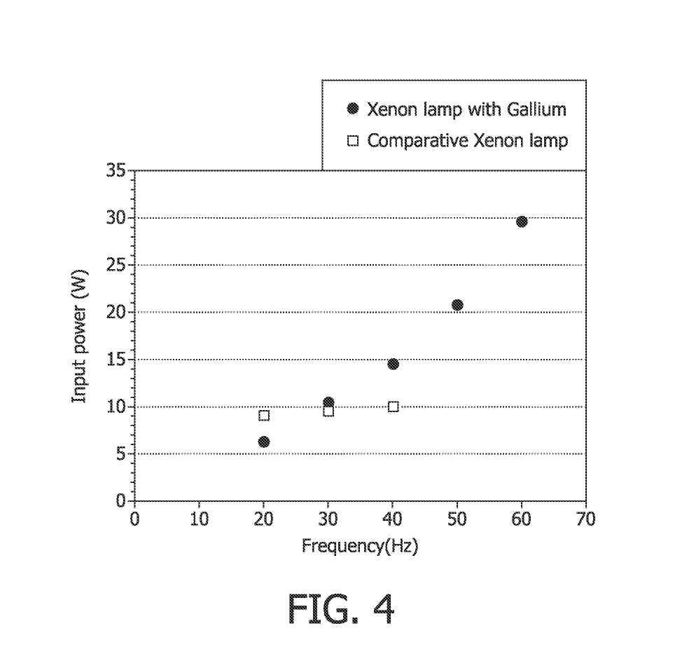

FIG. 3 shows a diagram of the Efficiency (in %) as a function of the input power for Example I and a comparative example without Gallium, FIG. 4 shows a diagram of the input power as a function of the frequency for both lamps.

The exact data is shown in Table II.

TABLE II

| | | | |
|---|---|---|---|
| frequency | efficiency | Input power | Optical output |
| (kHz) | (%) | (W) | power (W) |

EXAMPLE II

| | | | |
|---|---|---|---|
| 20 | 14.502% | 6.3349 | 0.918687198 |
| 30 | 15.756% | 10.4135 | 1.640735524 |
| 40 | 16.253% | 14.5278 | 2.361257598 |
| 50 | 19.914% | 20.8266 | 4.147417214 |
| 60 | 21.431% | 29.6623 | 6.357051817 |

Comparative Xenon lamp

| | | | |
|---|---|---|---|
| 20 | 17.51% | 9.1115 | 1.595706107 |
| 30 | 17.18% | 9.5074 | 1.633456887 |
| 40 | 16.71% | 10.0109 | 1.672951532 |

The beneficient effects of the present invention can be seen here quite well, too.

### Example III

A cylindrical quartz glass DBD lamp (length 12 cm, diameter 2.4 cm) of the gap distance of 4 mm was filled with 290 mbar Xe gas together with metallic Gallium piece of the weight ˜3.0 mg. The inside of the outer tube of the DBD lamp is coated by a phosphorescent material, YPO₄:Bi.

As a comparative example a lamp without the Gallium was used.

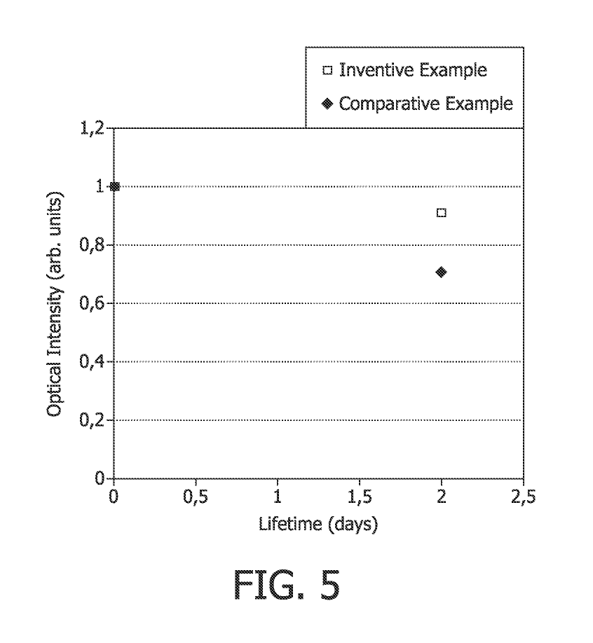

FIG. 5 shows the amount of degradation of the phosphorescent material and the decrease in the light output as a function of the lifetime of the lamps.

Table III shows the exact data.

TABLE III

Optical Intensity (Arb. Unit)

| Lifetime (days) | Example III | Comparative Example |
|---|---|---|
| 0 | 1 | 1 |
| 2 | 0.91 | 0.71 |

Almost no degradation was observed with the lamp of EXAMPLE III after a certain time period of burning the lamp, whereas the comparative Example shows strong degradation of the phosphorescent materials and reduction of the light output.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. Dielectric barrier discharge lamp comprising a discharge gas whereby at least one metal material is provided with the discharge gas.

2. Lamp according to claim 1, whereby the at least one metal material has a vapor pressure of ≦1.6×10² Pa at 400 K.

3. Lamp according to claim 1, whereby the at least one metal material has a melting point of ≧400 K.

4. Lamp according to claim 1, whereby the amount of the at least one metal material is ≧3×10⁻³ kg per m³ of the filling volume of the DBD lamp.

5. Lamp according to claim 1, whereby the at least one metal material is selected from the group comprising Aluminum, Gallium, Indium, Thallium, Silicon, Germanium, Tin, Lead, Magnesium, Calcium, Strontium, Barium, Cupper, Silver, and Gold.

6. Use of at least one metal material for increasing the radiance of the light emissions of DBD lamps and/or sustaining gas discharge channels in a DBD-lamp diffuse for higher input power in DBD lamps.

7. A method for improving the performance of a DBD lamp according to claim 1, comprising the step of heating the DBD-lamp.

8. Method according to claim 7, comprising the step of heating the DBD-lamp to at least a temperature of 50 degrees below the average melting temperature of the at least one metal material.

9. Use of at least one metal material as an oxygen getter in DBD-lamps.

10. A system comprising a DBD lamp of any of claim 1, the system being used in one or more of the following applications:
surface-modification,
ozone and/or radical molecule generation,
light generation,
disinfection of organic and inorganic materials,
copy machines
illumination applications
